(19) United States
(12) Patent Application Publication
(10) Pub. No.: US 2007/0273197 A1
(43) Pub. Date: Nov. 29, 2007

(54) Wheel Rim

(76) Inventor: Grantly Ross Smith, Samsonvale (AU)

Correspondence Address: SHUMAKER & SIEFFERT, P. A., 1625 RADIO DRIVE, SUITE 300, WOODBURY, MN, 55125, US

(21) Appl. No.: 10/588,178

(22) PCT Filed: Feb. 1, 2005
(86) PCT No.: PCT/AU05/00123

§ 371 Date: Mar. 20, 2007

(30) Foreign Application Priority Data
Feb. 21, 2004 (AU) 2004900445

(51) Int. Cl. B60B 21/06

(52) U.S. Cl. 301/58

(57) ABSTRACT

The present invention relates to a wheel rim comprising at least one track capable of operatively coupling to a spoke and located on an inner surface of the wheel rim. The at least one track in one preferred form is capable of operatively coupling to at least one carriage, which is capable of operatively coupling to the end of a spoke. The carriage in a preferred embodiment is adapted to retain a spoke nipple. The wheel rim is suitable for use with a bicycle wheel.

### FIELD OF THE INVENTION

THIS INVENTION relates to a rim for a wheel such as a bicycle rim, in particular a bicycle rim connected to a central hub by spokes.

### BACKGROUND OF THE INVENTION

A typical spoked wheel, such as a bicycle wheel, comprises an outer rim, a central hub and spokes connecting the rim and hub. A common spoke comprises two ends, one end is threaded and is capable of being threaded onto a spoke nipple and another end is non-threaded and terminates either with a bent hook or a straight head. The rim commonly comprises a channel for attaching a tire.

A common rim comprises a row of openings drilled along the channel to seat spoke nipples therein. Spokes are threaded onto each nipple and at an opposite non-threaded end of the spoke may be bent to form a hook or may be straight and end in a head that attaches to the hub. Tension of the spoke may be adjusted by turning the threaded nipple relative the threaded spoke, to thereby “true” the wheel. The nipple extends through the opening in the rim such that a head of the nipple faces outward from the wheel. A nipple wrench may engage a side of the nipple or a screw driver or nipple driver to be used to adjust the tension of the spoke.

The number of openings drilled into the rim determines the number of spokes for the wheel. The number of spokes, may be different for each rim, for example, a wheel may have 36 spokes, 32 spokes, 24 spokes or 20 spokes, however the total number of spokes is predetermined and fixed. Generally, fewer spokes is desired to reduce weight to thereby increase the speed a cyclist may travel. However, with fewer spokes, the wheel generally is weaker or is more expensive as stronger materials are required to reinforce the wheel. Also, the number of spokes for the wheel must match the number of opening in the rim and hub. If a cyclist has a hub that attaches to 20 spokes and has a spare rim having 36 openings for receiving spoke nipples, the hub and rim are not compatible and a new hub or rim needs to be purchased. Also, the angle of the spokes relative to the rim is fixed for a particular rim. A cross sectional shape of a rim may limit the angle of the spokes.

Some wheels use a tubeless tire that does not require an inner tube. Such a tire is lighter in weight, reduces risk of puncture due to pinching of the inner tube against the tire and if an object penetrates the tire, it often is temporarily self-sealing to allow the cyclist to complete their journey. However, use of a standard rim with a tubeless tire is problematic in that the opening the rim for seating the spoke nipples provides a location for passage of air to leak out from the tire.

One known rim overcomes the problem of air leaking through the rim by not drilling openings in the rim and instead secures the spoke nipple within individual slots located within an extension of the rim facing the hub. This rim, like a standard rim, has a fixed number of slots or openings for receiving a predetermined number of spoke nipples.

There is a need for a rim that may accommodate different number of spokes, different spoke angles and/or suitable for use with a tubeless tyre.

### SUMMARY OF THE INVENTION

It is an object of the invention to overcome one or more of the limitations of, or improve upon, the abovementioned background art or to provide a useful alternative.

In a first aspect the invention provides wheel rim comprising:

(a) a circular band; and

(b) a track located on the circular band capable of being operatively coupled to an end of a spoke.

Preferably, the track is capable of being operatively coupled to respective ends of at least two spokes.

Preferably, the end(s) of the spoke(s) are capable of sliding relative to the track.

The track preferably comprises a groove capable of receiving and retaining a carriage operatively coupled to a respective end of the spoke(s).

In one preferred form, the carriage is operatively coupled to a threaded end of the spoke(s).

Preferably, the carriage comprises a spoke nipple.

In another preferred form, the carriage is capable of being operatively coupled to a spoke nipple.

In yet another preferred form, the carriage is operatively coupled to a non-threaded end of the spoke(s).

Preferably, the non-threaded end of the spoke(s) comprises a hook or flat head.

In another preferred form, the track comprises a bar adapted to retain the end of the spoke(s).

Preferably, the bar is adapted to retain a hook end of the spoke(s).

In another form, the track comprises an outward extension capable of operatively coupling to a carriage.

Preferably, outward extension comprises a T-shape capable of mating with the carriage.

In a preferred form, the track is located on an inner surface of the circular band.

In another preferred form, the track comprises at least one channel located on each of two opposed side surfaces of the circular band.

Preferably, the wheel rim comprises a plurality of carriages.

The wheel rim preferably comprises a spacer carriage locatable on the track between adjacent carriages operatively coupled to a spoke nipple.

In on preferred form, the plurality of carriages are operatively coupled to a strip.

Preferably, the plurality of carriages are operatively coupled to the strip by an adhesive.

The circular band preferably comprises a single track.

Preferably, the single track extends substantially along an entire length of the circular band.

The circular band preferably comprises a plurality of tracks.

Preferably, at least two tracks.

More preferably, at least three tracks.

Even more preferably, at least four tracks.

Preferably, the track comprises at least one open end capable of receiving a carriage.

More preferably, the track comprises two open ends capable of receiving a carriage.

Preferably, the circular band comprises a channel located on an outer surface adapted to retain a tire.

Preferably, in one form the tire is capable of retaining an inner tube.

Preferably, in another form the tire comprises a tubeless tire.

Preferably, the wheel rim comprises a bicycle wheel rim.

In a second aspect, the invention provides a wheel comprising:

(1) a rim comprising:

(i) a circular band; and

(ii) a track located on the circular band;

(2) a plurality of spokes operatively coupled to the track and extending inwardly from the rim; and

(3) a hub located central of the wheel and operatively coupled to the rim by said plurality of spokes.

In a third aspect, the invention provides a carriage comprising a collar adapted to retain a spoke nipple, wherein the spoke nipple is rotatable within the collar and the carriage is insertable within a track located on a rim of a wheel.

In a fourth aspect, the invention provides a method for operatively coupling a plurality of spokes to a wheel rim, including the step of operatively coupling ends of a plurality of spokes to a track located on an inner surface of a circular band of the rim, wherein the end of the spokes when operatively coupled to the track are slidable relative thereto.

Preferably, the method further includes the step of operatively coupling the spoke to the carriage via a spoke nipple and operatively coupling the carriage to the track.

Preferably, the method still further includes the step of attaching one or more spacer carriages to the track between adjacent carriages.

Preferably, the method still further includes the step of attaching an opposite end of the spoke not attached to the carriage to a hub.

In a fifth aspect, the invention provides a kit for constructing a wheel rim comprising:

(a) a rim comprising at least one track; and

(b) a plurality of spoke carriages locatable on the track and capable of being operatively coupled to a spoke.

Preferably, the kit further comprises a plurality of spacer carriages locatable on the track between adjacent spoke carriages.

Preferably, the kit further comprises a plurality of spokes respectively operatively coupled to one or more spoke carriage(s) and a hub.

Throughout this specification unless the context requires otherwise, the word “comprise”, and variations such as “comprises” or “comprising”, will be understood to imply the inclusion of the stated integers or group of integers or steps but not the exclusion of any other integer or group of integers.

### BRIEF DESCRIPTION OF THE DRAWINGS

In order that the invention may be readily understood and put into practical effect, preferred embodiments will now be described by way of example with reference to the accompanying drawings wherein like reference numerals refer to like parts and wherein:

FIG. 1A is a cross sectional view of one embodiment of a rim of the invention comprising a track adapted to attach a spoke nipple;

FIG. 1B is the rim shown in FIG. 1A with a spoke and tire attached to the rim;

FIG. 2A shows a cross section of an embodiment of a rim without a mid-section and comprising a track capable of operatively coupling to a spoke nipple;

FIG. 2B shows a cross section of an embodiment of a rim without a mid-section and comprising a track capable of operatively coupling to a spoke hook end;

FIG. 2C shows a cross section of an embodiment of a rim without a mid-section and comprising a track capable of operatively coupling to a carriage capable of operatively coupling to a spoke nipple;

FIG. 3 is a cross sectional view of one embodiment of a rim of the invention comprising a track adapted to operatively couple to a hook of a spoke;

FIG. 4 is a side view of a rim capable of receiving and retaining a spoke hook end;

FIG. 5 is an exploded cross sectional view of one embodiment of a rim of the invention comprising a track operatively coupled to a carriage that is operatively coupled to a nipple of a spoke;

FIG. 6A is a cut away isometric view of a carriage adapted to retain a spoke nipple;

FIG. 6B is a cross sectional view of an embodiment of a carriage capable of retaining a spoke nipple and allowing for rotation of the spoke nipple within a collar;

FIG. 7A shows an isometric view of a strip capable of retaining a carriage thereon;

FIG. 7B shows an isometric view of a strip comprising apertures capable of retaining a carriage therein;

FIG. 7C shows an isometric view of a strip comprising apertures and counter sink for retaining a carriage therein;

FIG. 7D shows an isometric view of a strip comprising integral spoke retainers capable of retaining a spoke nipple;

FIG. 8 is an exploded cross sectional view of an embodiment of a rim comprising a track located on sidewalls of the rim;

FIG. 9 is an exploded cross sectional view of another embodiment of a rim of the invention comprising a T-shaped track operatively coupling to a carriage that is operatively coupled to a spoke nipple;

FIG. 10A is cross sectional view of a carriage for retaining a hook end of a spoke;

FIG. 10B is a cross sectional view of a carriage for retaining a non-threaded flat head portion of a straight spoke;

FIG. 11A is a cross sectional view of another embodiment of a carriage for retaining a hook end of a spoke capable of being inserted onto the T-shaped track shown in FIG. 9;

FIG. 11B is a cross sectional view of another embodiment of a carriage for retaining a non-threaded flat head portion of a straight spoke capable of being inserted onto the T-shaped track shown in FIG. 9;

FIG. 12A is a side view of a wheel comprising a single track;

FIG. 12B is a side view of a wheel comprising eight tracks;

FIG. 12C is a side view of a wheel comprising three tracks;

FIG. 13A shows the cross sectional view of the rim shown in FIG. 5 with a cover (shown as a spacer carriage) attached to the track; and

FIG. 13B shows the rim of FIG. 13A with a carriage, spoke nipple and spoke attached to the rim.

### DETAILED DESCRIPTION OF THE INVENTION

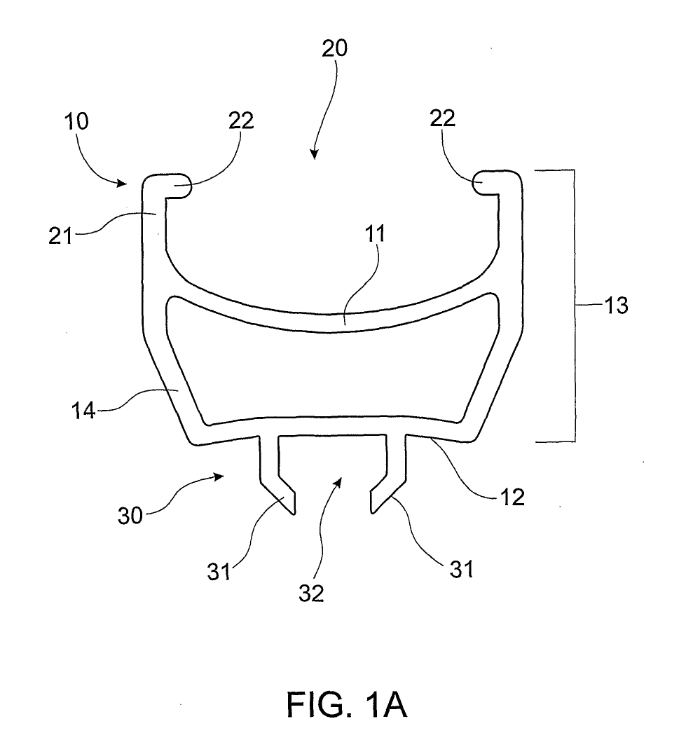

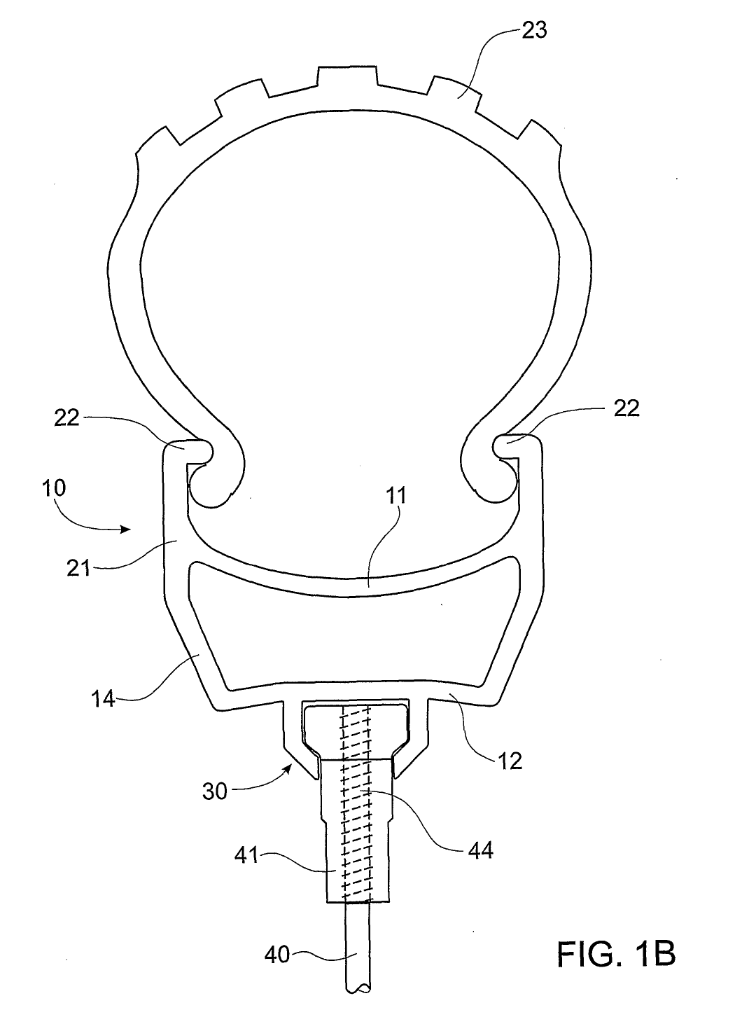

The invention in one embodiment generally relates to a wheel rim 10 shown in FIGS. 1A and 1B as a bicycle rim comprising a circular band 13 having a channel 20 located at an outer surface 11 of the band 13 and a track 30 located on an inner surface 12 of the band 13. The band is shown as a closed endless circular band 13. It is understood that the band 13 may be closed via an adhesive, for example glue or weld, and/or by retaining opposite ends of the band 13 adjacent to each other by a pin or joiner that force fit into open ends of the band 13.

The channel 20 comprises sidewalls 21 each terminating in a flange 22 for securing a clincher-type tire 23 that is common for many bicycle tires. The clincher-type tire comprises a continuous circular metal band that seats against the flange 22.

The track 30 comprises a pair of opposed sidewalls 31 defining a groove 32 adapted to receive a carriage, shown as a spoke nipple 41 that attaches to a threaded end 44 of a spoke 40, shown in FIG. 1B. The term “spoke nipple” is used generally herein to broadly refer to any member capable of operatively coupling to an end of a spoke, but preferably refers to a member capable of threading together with the threaded end of a spoke. The spoke nipple may comprise any shape or form and is not limited to a typical spoke nipple as shown herein. In one form, a spoke nipple comprises a carriage. A “carriage” refers to any member capable of being operatively coupled to a track, preferably capable of sliding relative to the track. A carriage comprises a liner or strip as described herein.

The track is operatively coupled to a spoke end, the term “operatively coupled” or “operatively coupling” meaning coupling either directly or indirectly between two or more integers. For example, the track may be directly operatively coupled to the spoke end wherein the track is directly in contact with the spoke. Also, the tract may be indirectly operatively coupled to the spoke end, for example via a carriage. Further, the track may be indirectly operatively coupled to a spoke end via a carriage that is operatively coupled to a spoke nipple that is operatively coupled to a threaded end of a spoke. Integers that are operatively coupled together may be removable from each other, for example, a threaded end of a spoke may be operatively coupled to a spoke nipple, which are threaded together, a spoke nipple may be retained within a collar of a carriage, etc.

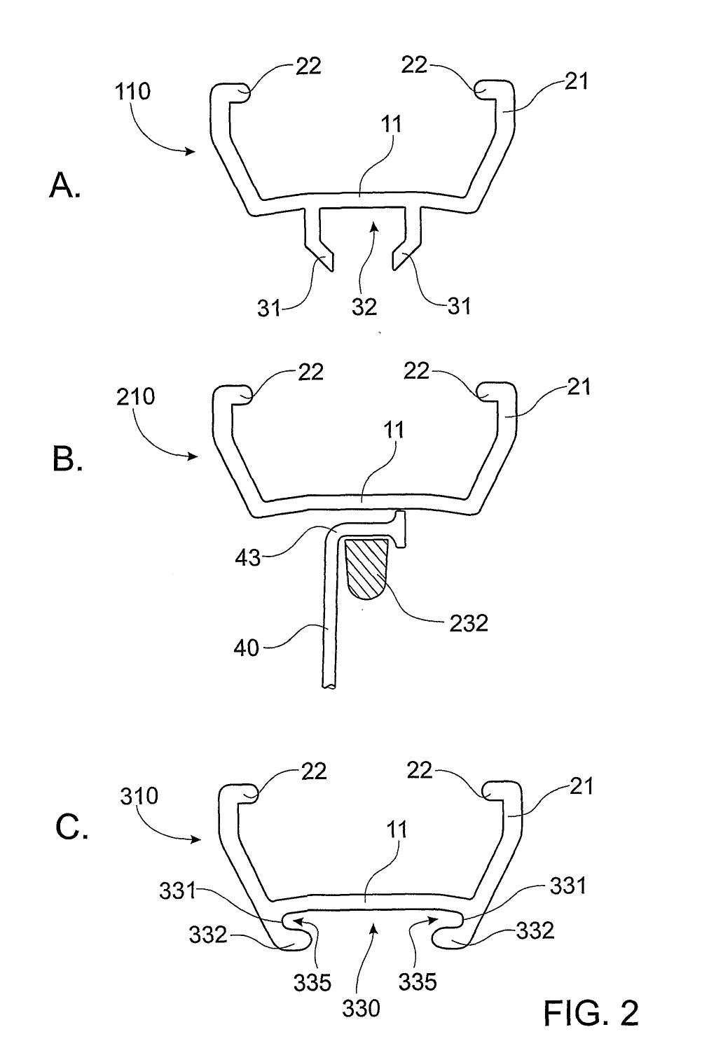

The band 13 is shown as a mid-section of a typical rim; however, it will be appreciated that the band may have any suitable shape and cross-section as is well known in the art. For example, the shape of the mid-section 14 may be V-shaped, curved, or substantially flat. Some rims 110, 210, 310 omit the mid-section 14 and have a single curved band as shown in FIGS. 2A-2C. Further, a sew-up type tire (also known as a “single”) may omit sidewalls 21 and flanges 22 as the tire is not attached to the rim via a clinching mechanism on the tire.

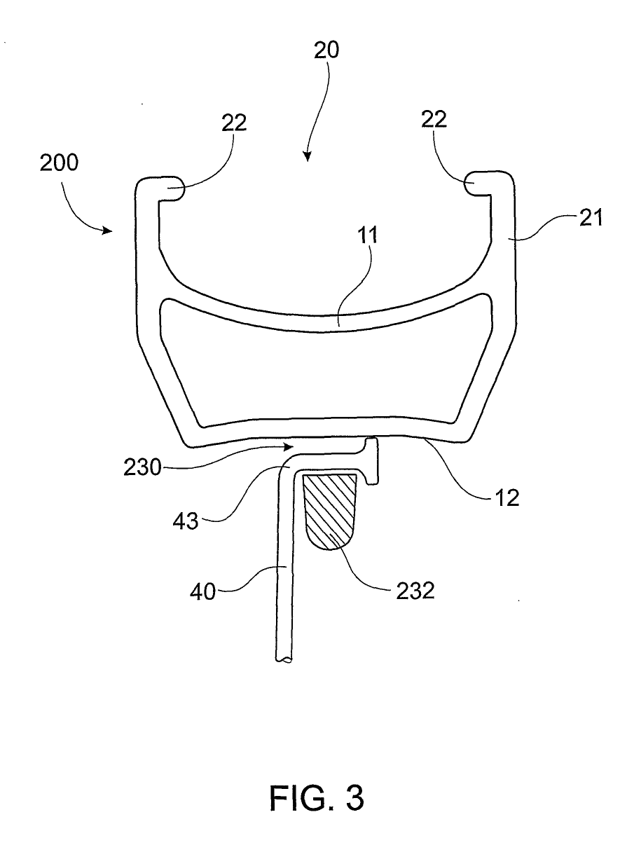

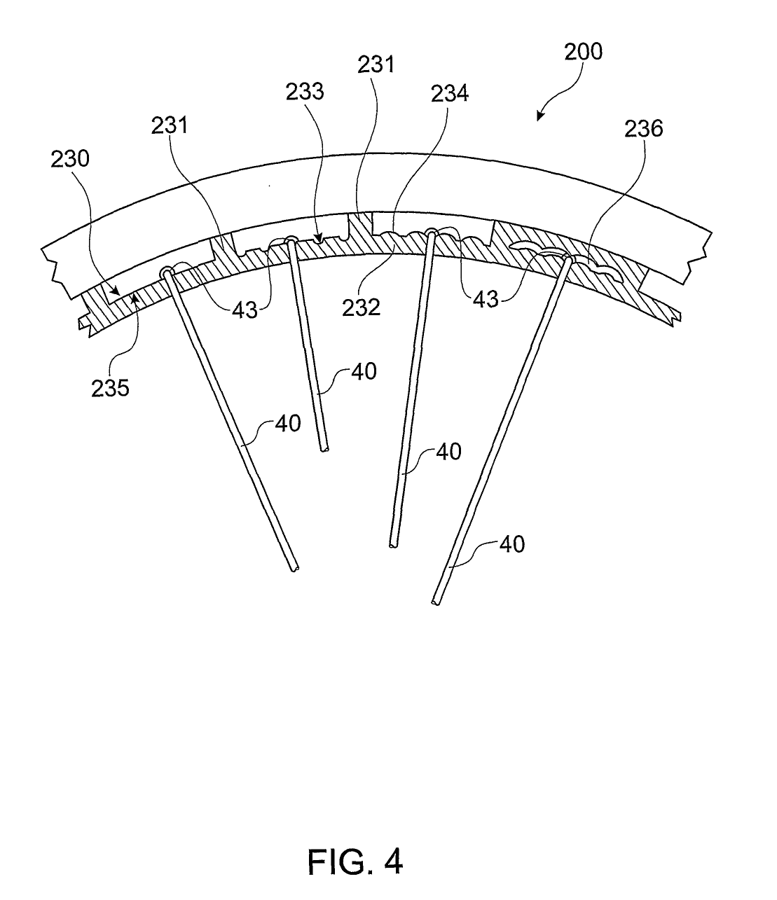

FIG. 3 shows another embodiment of the invention wherein the rim 200 comprises a track 230 that supports the hook 43 of a spoke 40. The track 230 comprises a support 231 shown in FIG. 4 that supports a bar 232 on which respective hooks 43 of each spoke 40 rests. The track 230 may comprise a slot 236 capable of receiving and retaining a hook 43 of a spoke 40 as shown. Spokes of a wheel attached to the rim shown in FIGS. 3 and 4 are slideable relative to the track 230 and are securely retained at a location on the track 230 (i.e. prevented from sliding along the track 230) when tension is applied to each spoke by tightening the nipple relative to the spoke. The bar 232 in one embodiment comprises indentations 233 to retain the hook 43 of the spoke 40. In another embodiment, the bar 232 comprises raised portions 234 for retaining the hook 43 of the spoke 40 therebetween. Alternatively, or in addition, the bar 232 is shown comprising a substantially linear surface 235, wherein the spoke hook 43 is retained by tension when the spoke is tightened.

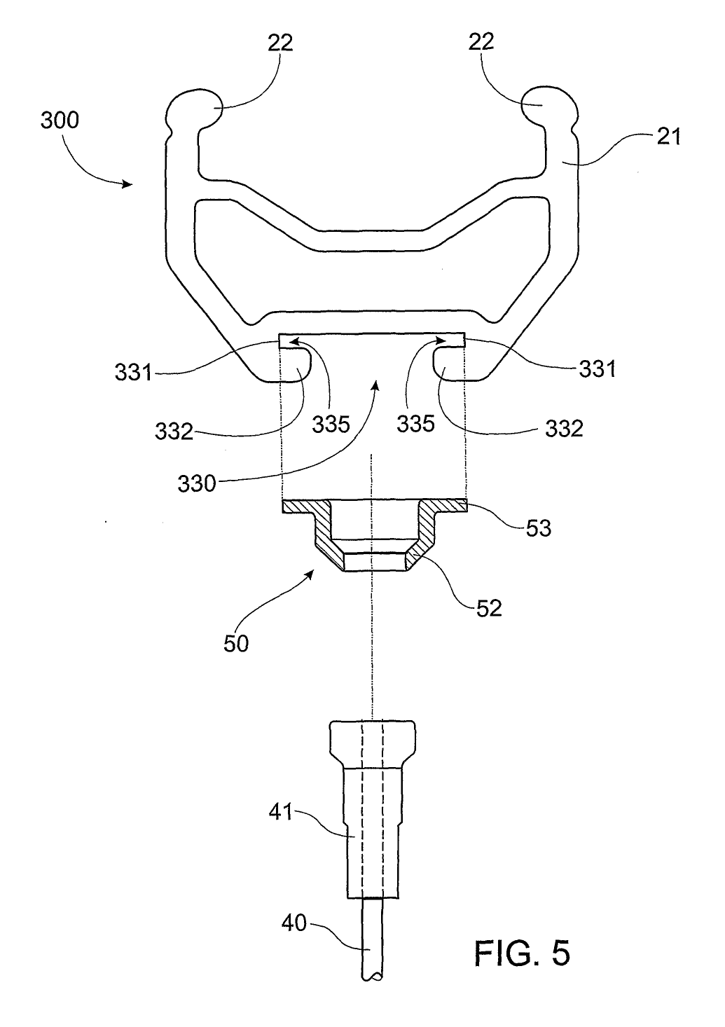

FIGS. 2C and 5 show embodiments of the invention wherein a rim 300, 310 comprises a track 330 that is capable of operatively coupling to a carriage 50 that is capable of operatively coupling to a spoke nipple 41. The carriage 50, with spoke nipple 41 operatively coupled to the spoke 40, is slideable relative to the track 330. In this manner, the spoke 40 is operatively coupled to the track 330. The track 330 is shown as a groove 335 having sidewalls 331 and retaining flanges 332 extending perpendicular to each sidewall 331. The sidewalls 331 and retaining flanges 332 define the groove 335 for carriage 50 to slide therein.

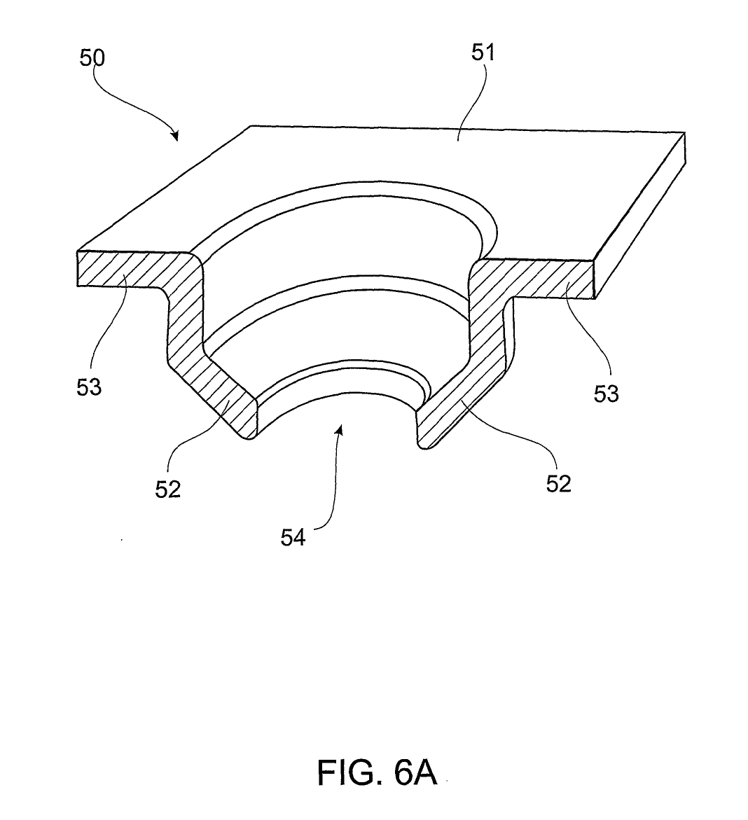

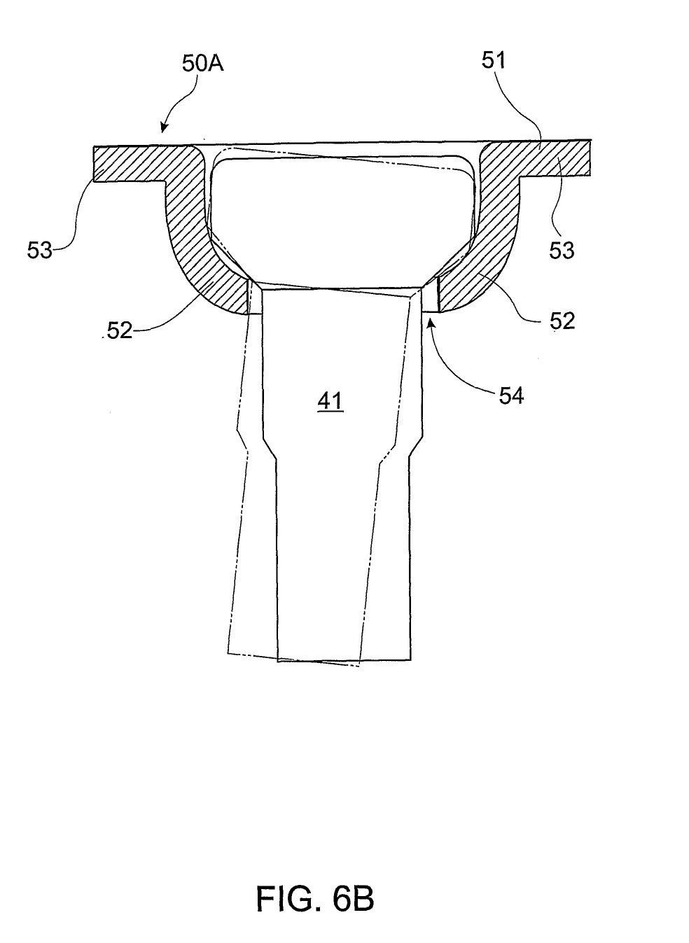

The carriage 50 shown in FIG. 5 is shown in isolation in FIG. 6A and a modified carriage is shown in FIG. 6B. Each carriage 50, 50A comprises a base 51 and a collar 52 that is adapted to receive the nipple 41 of a spoke 40. The base 51 comprises a tongue 53 that is capable of sliding within groove 335 of the track 330 shown in FIG. 5. The base 51 is shown square, however, it will be appreciated that other shapes of the base 51 are contemplated, for example rectangular, round, oval, triangular, or any other suitable shape that a person skilled in the art may select. For example, if the carriage is to be capable of rotation, the base may be circular, or if the carriage is not rotatable, the base may be square. One form of the carriage may have one pair of corners diagonal to each other that are rounded and another pair of corners diagonal to each other square so that the carriage may be rotated in one direction. The collar 52 is shown as a cross sectional view in FIG. 6A wherein the collar comprises a recess 54 that completely surrounds the nipple. However, in another embodiment the collar 52 comprises an open end or ends so that the spoke nipple may be slide into the recess 54. Also, the base 51 may comprise grooves or serrations on one or more surfaces contacting the track to increase friction therebetween and reduce unintentional movement of the carriage 50 relative to the track.

The spoke 40 may extend at any angle relative to the carriage or track. A suitable angle may be determined by a person skilled in the art, and such an angle may in part be determined by the style of rim, number of spokes, type of spokes, type of hub and the like. It will be appreciated that a carriage may comprise a pre-formed angle for retaining the spoke or spoke nipple so that for a single rim a particular carriage and spoke angle may be selected.

The carriage 50A comprises a shape capable of allowing the spoke nipple 41 to rotate within collar 52 as shown in FIG. 6B. The carriage 50A permits the spoke nipple 41 to extend from the collar 50A at different angles, for example, from zero when the spoke nipple 41 extends relatively straight from an aperture 54, to about 8 degrees, inclusive of all angles therebetween, for example, 1.0, 1.5, 2.0, 2.5, 3.0, 3.5, 4.0, 5.0, 6.0, 7.0 and 8.0, preferably at least between zero and 6 degrees, inclusive of all values therebetween. The shape of the carriage 50A is suitable of use with a standard spoke nipple 41 comprising a neck angle of about 45 degrees relative to the spoke head and is also suitable of a spoke nipple 41 comprising a rounded head portion. The shape of carriage 50A allows for the spoke nipple 41 to contact an inner surface of the collar 52 in at least two locations for a standard spoke nipple 41.

Accordingly, it will be appreciate that the present invention allows for a substantially greater number of angles of the spokes relative to the rim when compared with previously known rims. Many known rims comprise a cross sectional dimension (e.g. depth of the rim) that prohibits or limits the angle of the spoke relative to the rim. The carriage allows for angles of the spoke relative to the rim that were previously not possible. The angle of the spoke relative to the rim refers to both the angle in and out of the plan of the rim and also the angle within the plan of the rim. In one form, the collar may be rotatable relative to base or groove portion of the carriage.

For each of the embodiments shown in the drawings, the end of the spoke is capable of moving, preferably sliding, relative to the track, either with or without a carriage, before the spoke is tightened between the rim and a centrally located hub. This provides an easy means for changing a number of spokes for the wheel and allows for easy adjustment of spacing between adjacent spokes before tightening thereof.

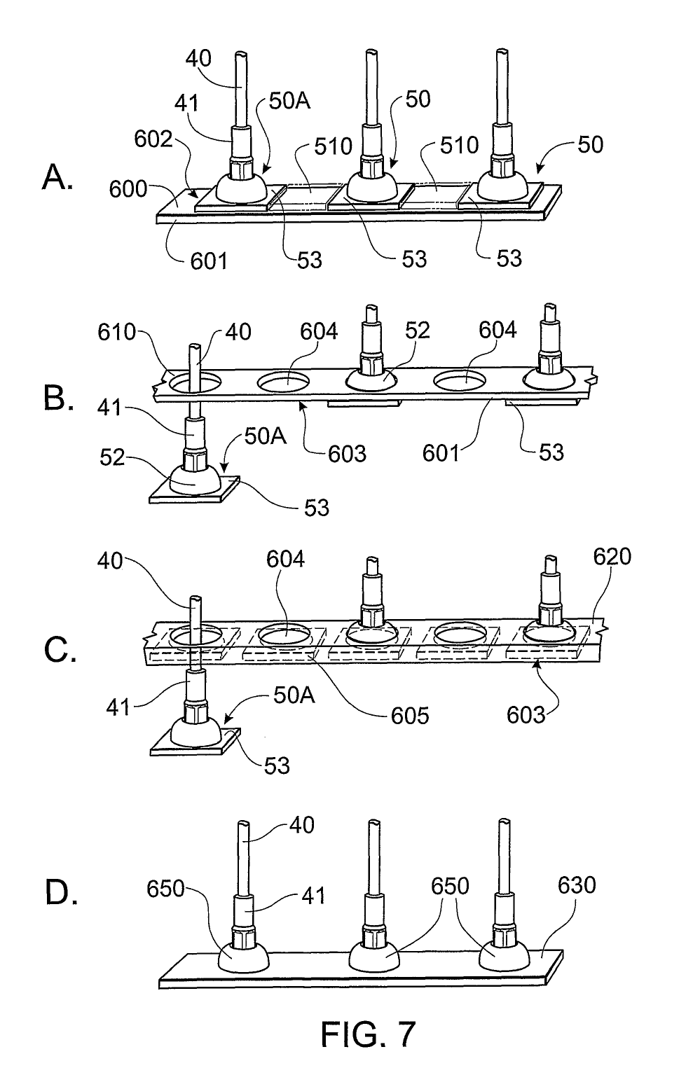

It will be appreciated that one embodiment of the invention may comprise a liner comprising a strip 600, 610, 620, 630 that is insertable into the track. Preferably, the liner substantially extends an entire length of the track and is adapted to retain at least one spoke nipple, as shown in FIGS. 7A-7D. In an embodiment shown in FIG. 7A, the liner comprises a strip 600 having a thickness 601 less than a width of groove 335 of the track 330 so that when a carriage 50, 50A is located on a surface 602 of liner 600 as shown, a combined thickness 601 of the strip 600 and base 53 is about a total thickness of the groove 335 of the track 330. In a preferred embodiment, the strip 600 comprises a thin strip about a thickness of adhesive tape, which functions to retain each carriage 50, 50A and/or spacer carriage 510 at a desired location before insertion onto the track.

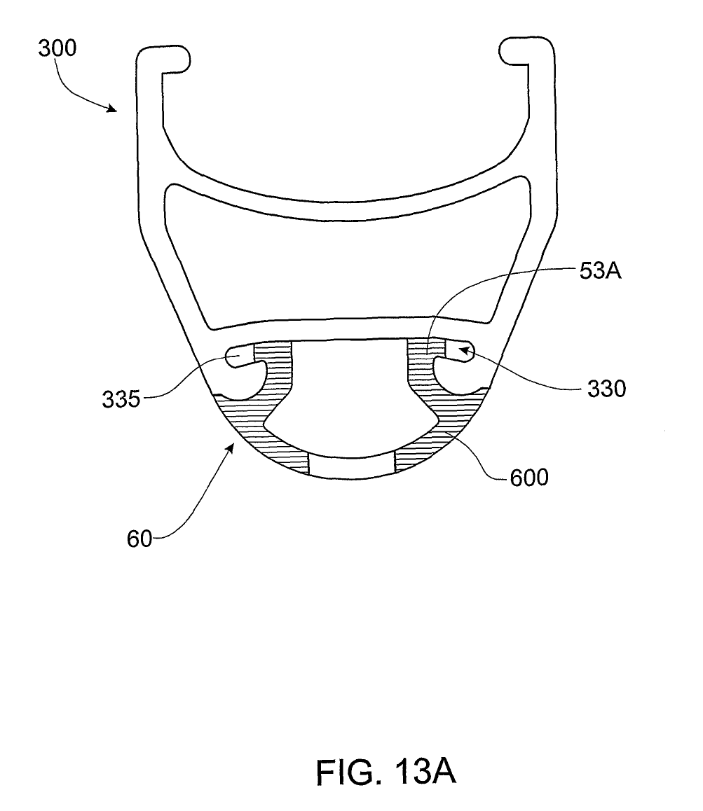

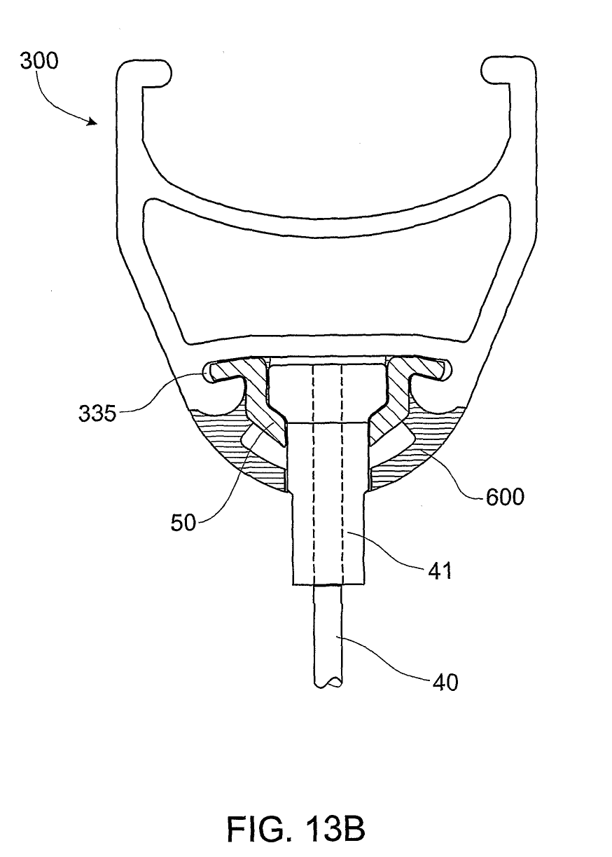

Spacer carriages 510 are shown located between carriages 50, 50A on strip 600. The spacer carriages 510 are shown as flat members about a thickness of the tongue of the carriage, however, the spacer carriages 510 may also comprise spacers as shown in FIGS. 13A and 13B. The strips 600, 610, 620, 630 with carriages 50, 50A located thereon are capable of being slid within the groove 335 of the track 330. The surface 602 in a preferred embodiment shown comprises an adhesive that is characterised as being sticky or tacky so that a carriage 50, 50A may be temporarily adhered to the surface 602 at any suitable location along the strip 600. Alternatively, the adhesive may comprise a permanent adhesive, for example, glue or a weld. A temporary adhesive allows for adjustment of a location of the carriage 50, 50A on the strip 600 after being inserted into the track. The strip 600 with carriages 50, 50A adhered thereto is capable of being inserted into groove 335 of the track 330, which simplifies insertion of the carriages 50, 50A. Either or both carriage 50 and/or carriage 50A, or any other suitable carriage, may be adhered to surface 602 of the strip 600. Also, a spoke nipple 41 is preferably located within the carriage 50, 50A before attachment to the strip 600.

An alternative embodiment of the strip 610 is shown in FIG. 7B, wherein the carriages 50, 50A are locatable adjacent to a surface 603. The carriages 50, 50A are insertable within an aperture 604 of the strip 610 so that the collar 52 is capable of protruding through the aperture 604 with the base 53 adjacent to the surface 603. A combined thickness of the strip 601 and the base 53 of the carriage 50, 50A is about equal to or less than a width of the groove 335 of the track 330 so that the strip 610 and carriage 50, 50A are capable of being slid into the groove 335 of the track 330.

FIG. 7C shown another embodiment of the strip 620 similar to the embodiment shown in FIG. 7B, however, the strip 620 comprises a counter sink portion 605 that is adapted to receive the base 53 of the carriage 50, 50A. When the carriage 50, 50A is inserted into the counter sink portion 605, the base 53 is substantially flush with the surface 603, inset relative thereto or protruding therefrom. Preferably, the base 53 is flush with the surface 603. This embodiment of the strip 620 is capable of being slid into the groove 335 of the track 330. Preferably, the spoke nipple 41 is inserted into the carriage 50, 50A before inserting the strip 620 with carriages 50, 50A into the track 330.

FIG. 7D shows an embodiment of the liner wherein the strip 630 comprises spoke retainers 650 formed integrally with the liner 630. The spoke retainers 650 perform a similar function as carriages 50, 50A and preferably comprise a similar structure thereof. Accordingly, for this embodiment, the strip 630 may replace the carriage 50, 50A. A spoke nipple 41 is preferably inserted into the spoke retainer 650 before inserting the strip 630 into the track. In one embodiment, the spoke nipple 41 is secured within the spoke retainer 650 as part of a pre-assembled strip. Alternatively, the spoke retainer 650 may comprise an aperture extending through the strip 630 through which a spoke nipple 41 may be inserted. The strip 630 may be formed by any method, for example press moulded. The abovementioned strips 600, 610, 620, 630 may be formed in lengths suitable for use with a specified circumference of a rim, or alternatively, may be provided as a continuous roll and cut to an appropriate length for use with a specific rim circumference.

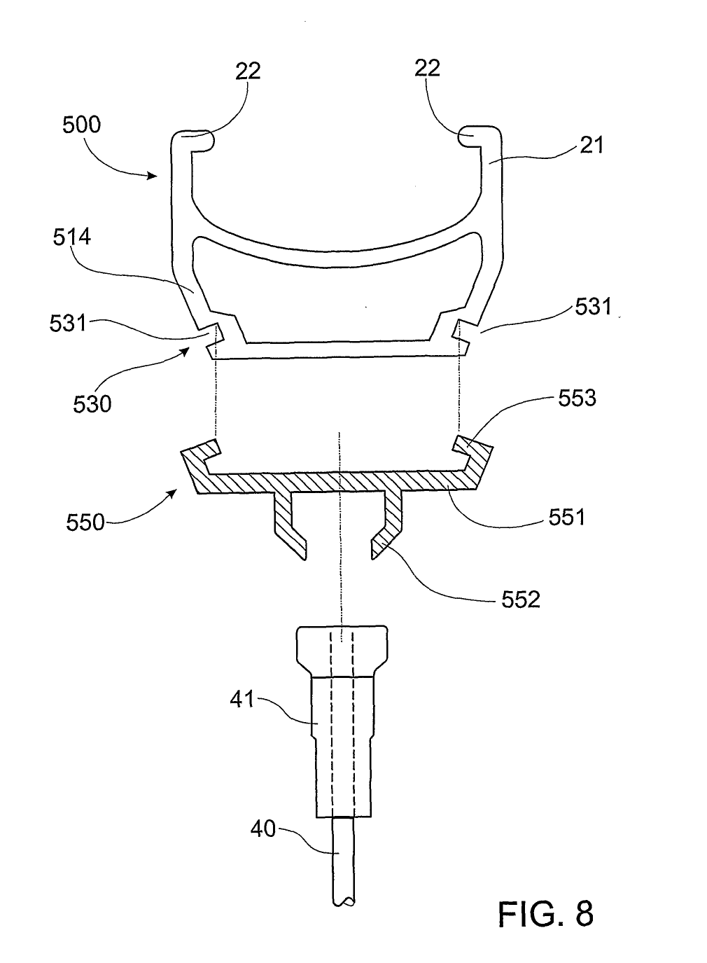

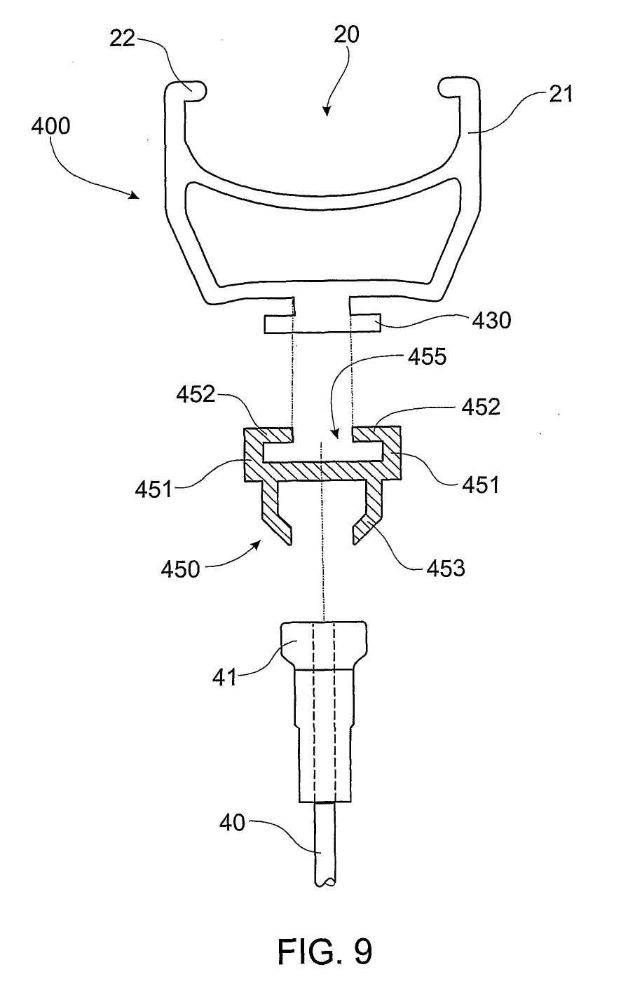

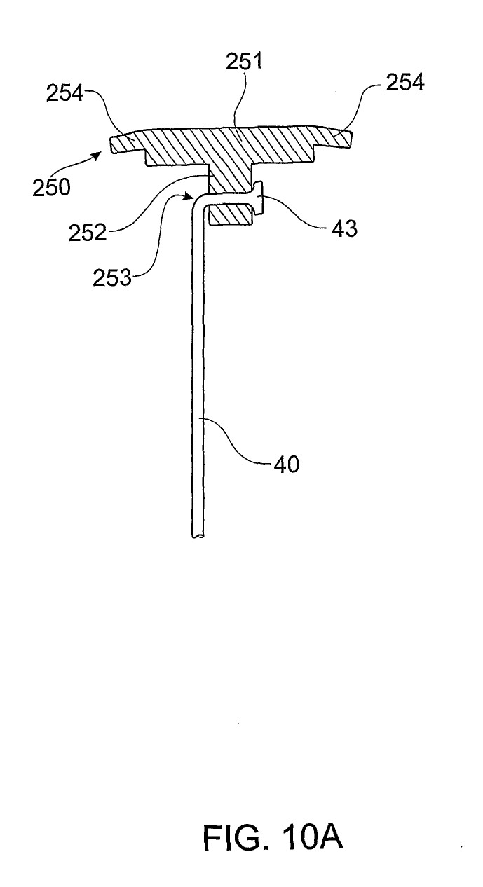

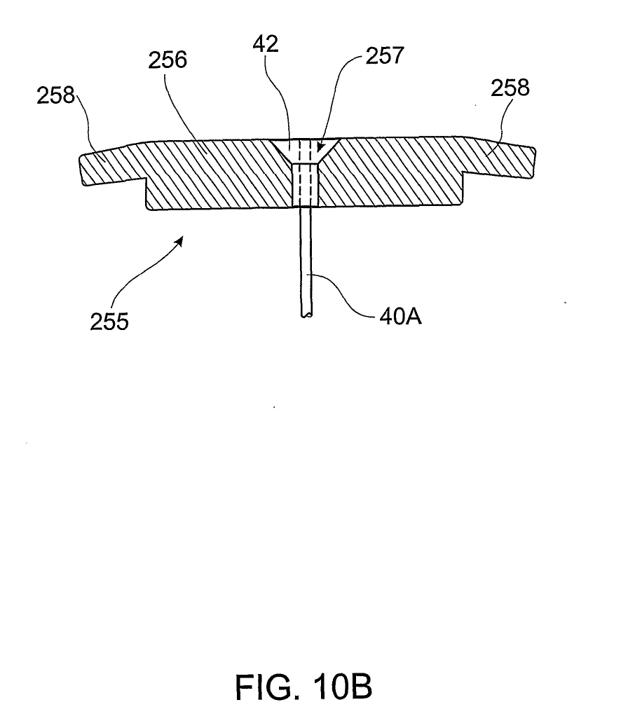

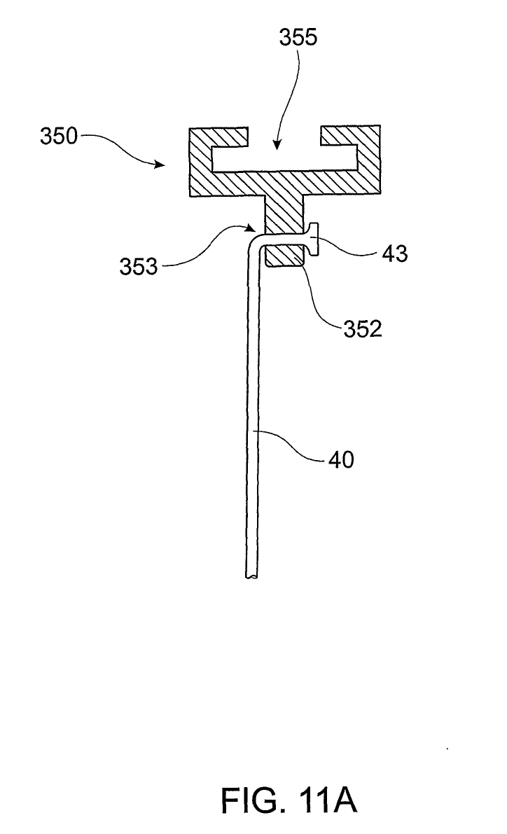

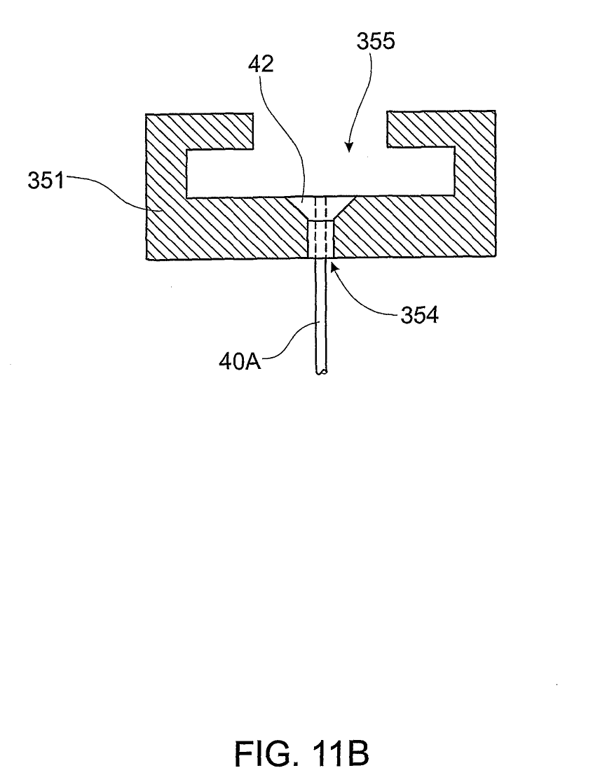

The strip as shown in FIGS. 7A-7D in an alternative embodiment may be adapted to retain a spoke nipple 41 for embodiments of a track 430, 530 shown in FIGS. 8 and 9, or a spoke end 42, 43 as shown in FIGS. 10A, 10B, 11A and 11B. An embodiment of a strip capable of mating with track 530 shown in FIG. 8 preferably comprises a cross sectional configuration similar to that of carriage 550. Preferably, the strip comprises a tongue similar to tongue 553 capable of insertion into track 530. Another embodiment of a strip capable of mating with track 420 shown in FIG. 9 preferably comprises a flange similar to flange 452 capable of operatively coupling the strip to the track 420. In another embodiment, a strip may comprise one or more member(s) 252 comprising an aperture 253 adapted to receive a hook 43 of a spoke 40 as shown in FIG. 10A. In still a further embodiment, a strip may comprise one or more aperture(s) 257 that is adapted to receive a head portion 42 of the straight spoke 40A as shown in FIG. 10B.

FIG. 8 shows an embodiment of the invention wherein the rim 500 comprises a track 530 in the form of a pair of grooves 531 located on mid-section 514 of sidewalls 21 as shown. A carriage 550 slides within the grooves 531 of the track 530 and is coupled thereto by tongue 553 of the carriage 550. The carriage is similar to the carriage 50 having a similar base 551 and collar 552 for retaining spoke nipple 41. The embodiment shown in FIG. 8 operatively couples a spoke 40 to the rim 500 via the carriage 550 and spoke nipple 41.

The rim 500 shown in FIG. 8 may have other suitable cross sections, including for example, omission of mid-section 514. Rims 110, 210, 310 lacking a mid-section are shown in respective FIGS. 2A-2C wherein like item numbers refer to like parts for items shown in FIGS. 1A, 3 and 5.

FIG. 9 shows another embodiment of the invention wherein a rim 400 comprises a track 430 comprising an outward projection comprising a T-shaped cross section. The carriage 450 is capable of moving relative to the track 430 by sliding along groove 455. The groove 455 is formed by a pair of opposed sidewalls 451, each having a flange 452 extending perpendicular to each sidewall 451. A collar 453 extends away from a surface of the carriage 450 as shown and the collar 453 is capable of operatively coupling to a spoke nipple 41 of a spoke 40.

Another form of a carriage suitable for use with the track 430 of FIG. 5 is shown in FIGS. 10A and 10B. FIG. 10A shows a carriage 250 capable of being operatively coupled to a spoke 40 comprising a bent hook end 43. The carriage 250 comprises a base 251 and a member 252 extending way from the base 251. The member 252 comprises at least one aperture 253 adapted to receive a hook 43 of a spoke 40. The carriage 250 is similar to the carriage 50 shown in FIGS. 6A and 6B, however, the collar is replaced with the member 252. The aperture 253 may comprise a circular shape, an elongate slit, notch or other suitable shape. It will be appreciated that an elongate slit may provide an additional means for adjusting a location of the spoke end relative to the rim 10 as will be described in more detail hereinafter. The base 251 comprises a tongue 254 that is capable of sliding within the groove 335 of track 330 as shown in FIG. 5.

FIG. 10B shows another embodiment of a carriage 255 that is adapted to receive a head of an end of a straight spoke 40A opposite a threaded end that engages a nipple. The carriage 255 comprises a base 256 comprising an aperture 257 that is adapted to receive a head portion 42 of the straight spoke 40A. The base 256 comprises a tongue 258 as shown that is capable of sliding within groove 335 of the track 330 shown in FIG. 5 in a similar manner as the carriage 50. This embodiment of the carriage 255 is capable of operatively coupling the spoke 40A to the track 330.

FIG. 11 A shows another form of a carriage 350 comprising a groove 355 similar to that shown for carriage 450 in FIG. 9, capable of moving along the T-shaped track 430. However, the carriage 350 comprises a member 352 that comprises an aperture 353 that is adapted to receive a hook 43 of a spoke 40, similar to that shown in FIG. 10A. The aperture 353 may be circular, an elongate slit, notch or the like. The carriage 350 is capable of operatively coupling the spoke 40 to the tract 430.

FIG. 11B shows an embodiment of a carriage 351 that is similar to the carriage shown in FIG. 11 A that is capable of operatively coupling to the T-shaped track 430. Carriage 351 comprises a an aperture 354 for engaging an head portion 42 of a straight spoke 40A and a groove 355 for engaging the track 430 comprising a substantially T-shape.

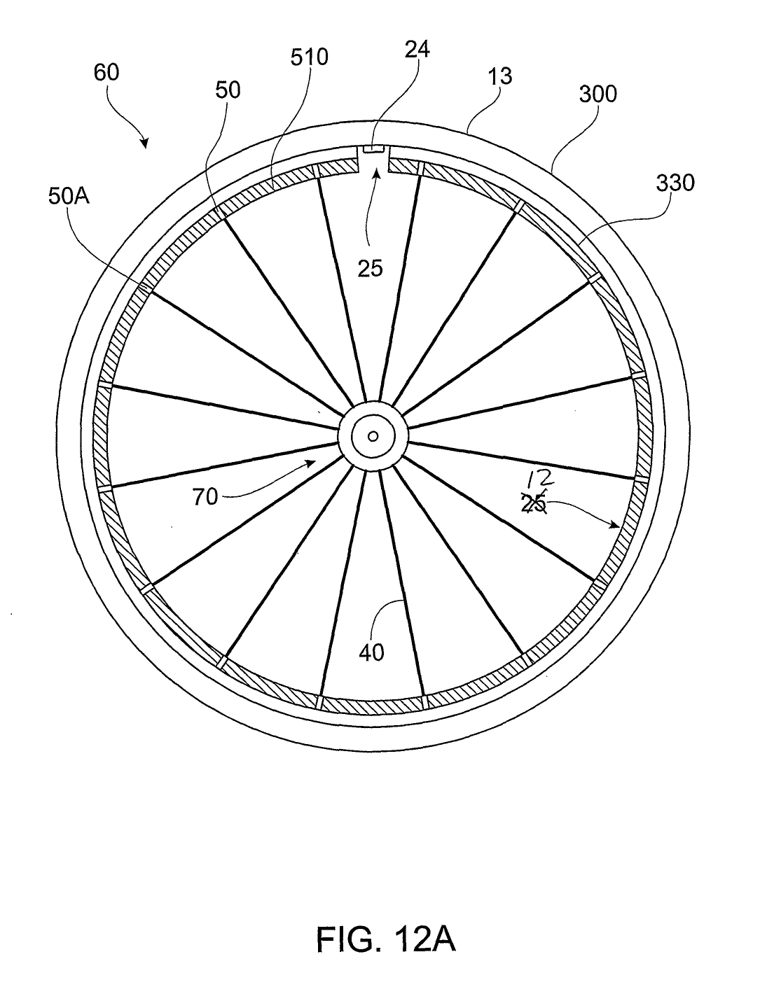

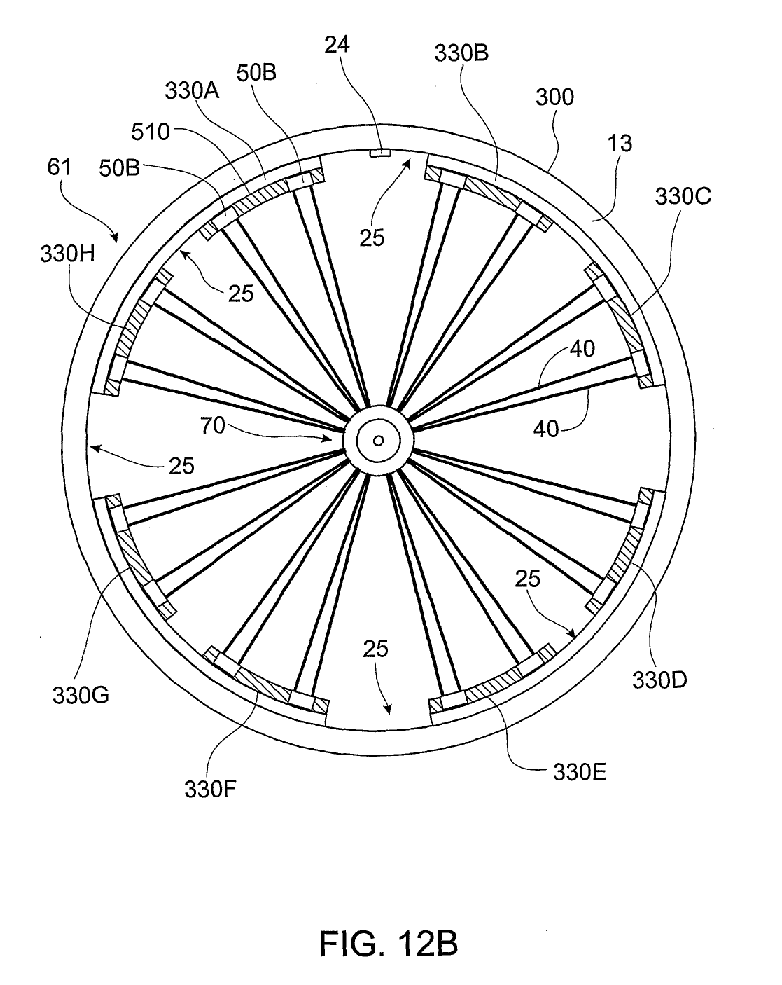

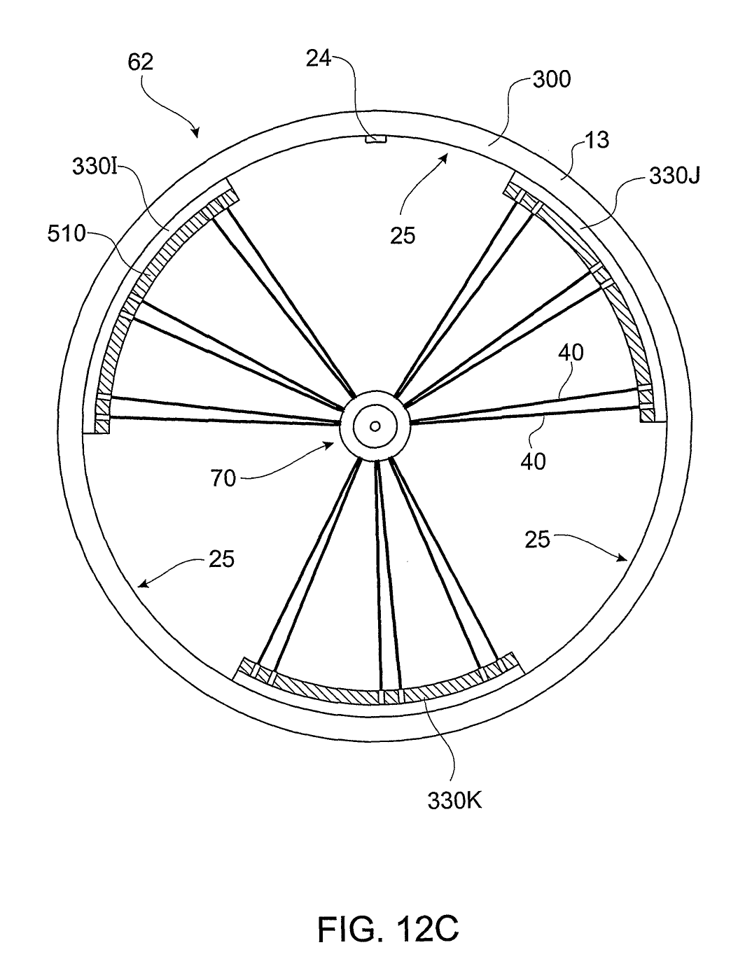

FIG. 12A shows a wheel 60 comprising a rim 300 comprising a circular band 13 and a single track 330 extending along the inner surface of the rim 300, a tire is not shown, but is locatable on an outer surface of the circular band 13. The wheel 60 also comprises a central hub 70. Track 330 may accommodate any suitable number of spokes 40, or spokes 40A. For this embodiment, a gap 25 is formed at ends of the track 330 adjacent to an aperture 24 through which an air valve of a tire may be inserted. For a tubeless tire, the air valve may comprise O-rings or other suitable sealing means located around the valve to prevent unwanted air loss from within the tire. The gap 25 also provides a location for inserting the carriage(s) onto the track 330. It will be appreciated that the track preferably comprises at least one open terminal end, more preferably both terminal ends are open as shown in FIG. 12A so that one or more carriages may be slid thereon. In relation to embodiments comprising a plurality of tracks as described hereinafter, each track preferably comprises at least one open terminal end and more preferably both terminal ends are open. However, other embodiments of the invention comprise an endless circular track without a terminal end. For this embodiment, one or more carriages may be operatively coupled to the track by clipping the carriage onto the track, for example by bending a base 51 of the carriage before inserting on the track.

Once the carriage(s) are operatively coupled to the track(s), the or each carriage is preferably capable of moving relative to the track along a length thereof.

Spacer carriages 510 may be located on track 330 between adjacent carriages 50, 50A. The spacers 510 fill in spaces on the track 330 between carriages 50, 50A, which may further prevent inadvertent sliding of the carriage 50, 50A, reduce wind resistance, prevent debris from entering the track and may improve aesthetics. The spacers 510 are shown in the form of a flat spacer carriage without a means for attaching a spoke end and capable of sliding within track 330. The spacers 510 may also comprise covers 600 as shown in FIGS. 13A and 13B. The spacers may further comprise reflective material, any colouration and/or writing, for example a brand name, rim model, etc, which is preferably screen printed onto the spacer 510.

It will be appreciated that the spacers 510 are of a suitable length so that a distance between adjacent carriages 50, 50A, and spokes 40 attached thereto, are of a desired separated length. The spacers 510 are each shown as a single contiguous member between adjacent carriages 50. However, it is contemplated that a plurality of spacers may be located between adjacent carriages 50. Accordingly, a distance separating adjacent carriages 50 may be predetermined by a user and an appropriate length spacer, or plurality of spacers, located onto the track 330.

Also, each carriage may be adapted to retain one or more spokes. For example, FIGS. 12A and 12C show carriage 50, 50A adapted to retain a single spoke 40 and carriage 50B shown in FIG. 12B is adapted to retain two spoke ends. Also contemplated are carriages adapted to retain three or more spoke ends. Further, an embodiment of a carriage capable of operatively coupling to a plurality of spokes preferably comprises a liner or strip as described herein. It will also be appreciated that in addition to typical spokes (e.g. straight spokes and hooked spokes), other support arms that extend between the rim 300 and the hub 70 may likewise be attached to a carriage and used in accordance with the invention.

In alternative embodiments, the invention may comprise a plurality of tracks 330, as shown for wheels 61 and 62 in FIGS. 12B and 12C. The wheel 61 shown in FIG. 12B comprises eight tracks 330A-330H. The wheel 62 shown in FIG. 12C comprises three tracks 330I-330K. For embodiments of track 330 that comprise a plurality of tracks 330A-330K, it is preferred that each track 330A-330K is located at equal distances along the inner surface 12 as shown in FIGS. 12B and 12C. This allows for equal spacing of the spokes 40 around the rim 300. It will be appreciated that other arrangements of the track 330 are possible as long as the carriages and/or spokes may be operatively coupled to the track 330.

The spacing of the track 330 may be determined based in part on the number of spokes 40 located within the wheel. For example, if a single track 330 is substantially continuous (e.g. comprises a single gap between adjacent ends of the track 330 of sufficient size to allow for a spoke and/or carriage to be slide onto the track 330) as shown in FIG. 12A, any number of spokes may be used. If the rim comprises eight tracks 330A-330H or three tracks 330I-330K, preferably an equal number of spokes are attached to each track 330A-30K. FIGS. 12A-12C merely show examples of possible spoke arrangements and other suitable arrangements are possible as a skilled person may select.

It will be appreciated that a rim 300 may comprise any suitable number of tracks including for example, one, two, three four, five, six, seven, eight, nine or more tracks. It will also be appreciated that gaps 25 may be of any suitable length and in a preferred embodiment a track may comprise a gap 25 between every two spokes or carriages attached to the track as shown in FIG. 12B. This embodiment allows for easy attachment of the spokes or carriages to the track as each spoke or carriage may be inserted onto the track at an open end thereof adjacent to gaps 25 located on opposite ends of the track. For such an embodiment, the rim may comprise eight or more tracks, for example, 9, 10, 11, 12, 13, 14, 15, 16, 17, 18, 19, 20, 21, 22, 23, 24, 25, 26, 27, 28, 29, 30 or more tracks wherein each track is capable of retaining at least one spoke, preferably at least two spokes, or more spokes, preferably operatively coupled to a carriage. It is preferred that each track comprises at least one open end located adjacent to a gap 25, but more preferably both ends are open to allow insertion of a spoke or carriage from either end of the track.

It will be appreciated that because the spokes 40 can slide along the track 330 within carriage 50 before tightening, the final number of spokes 40 attached to a wheel 60, 61, 62 may be varied. This allows for the number and type of spoke of the wheel to be changed without having to change rims. The number of spokes and type of spokes may be changed to reduce weight or strengthen the wheel. Further, the number of spokes may be selected based on the number of spoke attachment openings of hub 70 without having to purchase a separate rim to match the predetermined number of spokes for the hub. This would be the case for a standard rim that has a fixed number of pre-drilled apertures for retaining nipples 41.

It will be appreciated that although embodiments of wheels 60, 61, 62 shown in FIGS. 12A-12C comprise a rim having a track 330, the other tracks referred to herein may be located on the rim in a same or similar manner as described for track 330. It will also be appreciated that any number or type of carriage and/or liner described herein may be used with a mating track for operatively coupling a spoke to the track. Also, any suitable type of spoke, including spokes 40, 40A, may be used. It is preferred that the track is sufficiently long to allow for the spoke, or carriage, to slide to a location allowing for a proper arrangement of spokes relative to the rim.

FIGS. 13A and 13B show the rim of FIG. 5 comprising a cover 600. The cover 600 is another embodiment of a spacer and is capable of being inserted into the track 330. The cover 600 is shown arcuate or curved, however, other suitable shapes include teardrop shaped, triangular square or any other shape. The shape may be selected based on aerodynamics and/or aesthetics. The cover 600 may be reflective to improve visibility of the rim, for example to improve visibility when a cyclist is riding a bicycle with the rim of the invention.

The cover 600 attaches to the track 330 in a similar manner as carriage 50. The cover 600 comprises a tongue 53a that is capable of sliding within groove 335 of the track 330. In one embodiment, the cover 600 also functions as a spacer 510, as described for FIGS. 12A-12C. An end of the cover 600 that is located adjacent to a carriage 50, and therefore adjacent to a spoke nipple 41, preferably comprises an indentation 601 as shown in FIG. 13B. The indentation 601 is arcuate in shape, preferably a semi-circle. The indentation 601 enables the cover 600 to extend around one half of a spoke nipple 41 and when two covers 600 are located on opposite ends of the carriage 50 an entire spoke nipple 41 is surrounded by the cover 600 as shown in FIG. 13B.

In one embodiment, the cover may form part of the track as an integral part of the rim. For such an embodiment, a slit is located within the cover to allow the spokes to be slid onto the rim. The cover may be made of any suitable material, but is preferably light weight.

It will be appreciated that the present invention is suitable for use with typical clincher tires, sew-up tires and tubeless tires, or a wheel lacking a tire. In relation to tubeless tires, the present invention is particularly well suited as there is no need to drill holes into the rim to accommodate the spoke nipples. Accordingly, the spoke nipples do not extend through the rim into the channel portion 20 where the tubeless tire is attached. This prevents possible leakage of air through hole of a typical rim.

For each of the embodiments of the invention, the spokes are firmly retained in place relative to the track when tension is applied to the spoke during typical lacing of a wheel, which tightens each spoke located between the rim and hub. Before the spoke is tightened, the spoke end may be slide relative to the track. For example, the hook may slide relative to the bar, the spoke nibble may slide relative to the track or a carriage may slide relative to the track. It is contemplated that for embodiments of the invention comprising a carriage, the carriage may be slide onto the tract and then the spoke attached to the carriage or alternatively the spoke may be attached to the carriage and the carriage, with the attached spoke, slide onto the track. In either embodiment, the spoke once attached to the track, either directly or indirectly via a carriage, is slideable relative to the track before the spoke is tightened.

The location of the spokes may be arranged by sliding the spoke relative to the track before tension is applied to the spoke. The circular endless band of the rim may optionally have indicators, or example a mark, on the rim to indicate a proper location for positioning a spoke. The rim may have different indicators for a different number of total spokes for the wheel. For example a single line may indicate a spoke location for a wheel having 24 spokes and a double line may indicate a spoke location for a 32 spoke wheel. Preferably, the mark is visible, but faint as to not detract from the aesthetics of the rim. Alternatively, use of the spacers 510 removes the need for markings along the rim.

Because the spokes may be slide onto the track, either directly or indirectly via a carriage, the number of spokes for the wheel may vary depending on the wheel and hub. As such, a single rim may be mass produced and the number of spokes used to make the wheel later determined. This is an advantage over known rims that comprise a predetermined fixed number of holes for receiving a fixed number of spoke nipples. Also, different rims are not required when changing the number of spokes for a wheel. Further, a hub has a predetermined fixed number of opening for receiving an end of a spoke. The present invention allows for a hub to be used with any rim as the rim may accommodate different numbers of spokes.

The present invention is ideal for use with common off the shelf components. For example, some hubs attach to spokes via the hook end, while other hubs attach to spoke via the nipple end. It will be appreciated that a suitable carriage as described herein may be used to accommodate either spoke end, thereby any kind of common hub may be used with the present invention. Accordingly, a single rim may be mass produced and the form of the carriage used for a particular hub design.

It will further be appreciated that the present invention may be used with most, if not all, presently available rim designs. That is, the track may be located on an inner surface of a rim having essentially any cross sectional profile. Accordingly, the rim of the invention may comprise a mid-section or other reinforcing structures, no reinforcing structure or no mid-section. Also, the rim may be used with any wheel comprising spokes, for example wheels for a mountain bicycle, road bicycle, racing bicycle, wheel chair, unicycle, tricycle, car, motorcycle, scooter, trolley, cart, carriage, gear, spindle and the like. Further, it will be appreciated that the invention comprising a rim having a track and carriages locatable on the track may be suitable for use with non-spoked wheels. For example, a wheel comprising one or more blades connecting the rim to a central hub. The features of the present invention allow a wheel rim support, for example a spoke or blade, to be operatively coupled to the rim via a track located thereon and provides the advantages as described herein over known rims.

It will be appreciated that for some embodiments of the invention, the track(s) may be formed integrally with the rim, for example as an extrusion. Alternatively, the tracks may be attached or mounted to the rim by a fastening means, such as by welding, rivet, bolt, screw, adhesive and the like. Preferably, the track is formed as an extrusion to reduce manufacturing cost and time. The track may be used with any suitable rim, including for example rims that are welded together and/or rims that are assembled using locking pins or joiners as are known in the art.

In one embodiment, the invention provides a kit comprising a rim comprising at least one track, a plurality of carriages and a plurality of spacers, and/or a strip capable of retaining one or more spoke ends and insertable within the track as discussed above. A rim may be assembled by selecting carriages of appropriate configuration (e.g. capable of retaining a desired spoke design and end of spoke, comprising an appropriate angle for the spoke, etc), selecting a desired number and/or length of spacers and placing the carriages and spacers onto the track in a desired order so that spacing between carriages corresponds to a desired spoke number, spacing and angle relative to the rim. The kit may further comprise a hub and a plurality of spokes. A kit comprising a strip may provide a convenient means for inserting the carriages onto the track. The embodiment of the strip 630 comprising integral spoke retainers 650 may be selected based on the number of desired spokes, which preferably corresponds with the number of spoke retainers 650.

Although the invention has been shown and described with exemplary embodiments thereof, it should be understood by those skilled in the art that the foregoing and various other changes, omissions and additions may be made therein and thereto without departing from the scope of the invention.

1. A wheel rim comprising:
(a) a circular band; and
(b) a track located on the circular band capable of being operatively coupled to an end of a spoke.

2. The wheel rim of claim 1 wherein the track is capable of being operatively coupled to respective ends of at least two spokes.

3. The wheel rim of claim 1 or claim 2 wherein the end(s) of the spoke(s) are capable of sliding relative to the track.

4. The wheel rim of claim 3 wherein the track comprises a groove capable of receiving and retaining a carriage operatively coupled to an end of the spoke(s).

5. The wheel rim of claim 4 wherein the carriage is operatively coupled to a threaded end of the spoke(s).

6. The wheel rim of claim 5 wherein the carriage comprises a spoke nipple.

7. The wheel rim of claim 4 wherein the carriage is operatively coupled to a non-threaded end of the spoke(s).

8. The wheel rim of claim 7 wherein the non-threaded end of the spoke(s) comprises a hook or flat head.

9. The wheel rim of claim 3 wherein the track comprises a bar adapted to retain the end of the spoke(s).

10. The wheel rim of claim 9 wherein the bar is adapted to retain a hook end of the spoke(s).

11. The wheel rim of claim 5 wherein the carriage is operatively coupled to a spoke nipple.

12. The wheel rim of claim 3 wherein the track comprises an outward extension capable of operatively coupling to a carriage.

13. The wheel rim of claim 12 wherein outward extension comprises a T-shape capable of mating with the carriage.

14. The wheel rim of any one of claims 1 to 13 wherein the track is located on an inner surface of the circular band.

15. The wheel rim of any one of claims 1 to 13 wherein the track comprises at least one channel located on each of two opposed side surfaces of the circular band.

16. The wheel rim of claim 4 or claim 11 comprising a plurality of carriages.

17. The wheel rim of claim 16 comprising a spacer carriage locatable on the track between adjacent carriages operatively coupled to a spoke nipple.

18. The wheel rim of claim 16 wherein the plurality of carriages are operatively coupled to a strip.

19. The wheel rim of claim 18 wherein the plurality of carriages are operatively coupled to the strip by an adhesive.

20. The wheel rim of any one of claims 1 to 19 wherein the circular band comprises a single track.

21. The wheel rim of claim 20 wherein the single track extends substantially along an entire length of the circular band.

22. The wheel rim of any one of claims 1 to 19 wherein the circular band comprises a plurality of tracks.

23. The wheel rim of claim 22 comprising at least two tracks.

24. The wheel rim of claim 23 comprising at least three tracks.

25. The wheel rim of claim 24 comprising at least four tracks.

26. The wheel rim of claim 1 wherein the track comprises at least one open end capable of receiving a carriage.

27. The wheel rim of claim 26 wherein the track comprises two open ends each capable of receiving a carriage.

28. The wheel rim of any one of claims 1 to 27 wherein the circular band comprises a channel located on an outer surface adapted to retain a tire.

29. The wheel rim of claim 28 wherein the tire is capable of retaining an inner tube.

30. The wheel rim of claim 28 wherein the tire comprises a tubeless tire.

31. The wheel rim of any one of claims 1 to 30 wherein the wheel rim comprises a bicycle wheel rim.

32. A wheel comprising:
(1) a rim comprising:
(i) a circular band; and
(ii) a track located on the circular band;
(2) a plurality of spokes operatively coupled to the track and extending inwardly from the rim; and
(3) a hub located central of the wheel and operatively coupled to the rim by said plurality of spokes.

33. The wheel of claim 32 further comprising a tire located on the outer surface of the rim.

34. The wheel of claim 33 wherein the wheel further comprises an inner tube located within the tire.

35. The wheel of claim 33 wherein the tire comprises a tubeless tire.

36. A carriage comprising a collar adapted to retain a spoke nipple, wherein the spoke nipple is rotatable within the collar and the carriage is insertable within a track located on a rim of a wheel.

37. A method for operatively coupling a plurality of spokes to a wheel rim, including the step of operatively coupling ends of a plurality of spokes to a track located on an inner surface of a circular band of the rim, wherein the end of the spokes when operatively coupled to the track are slidable relative thereto.

38. The method of claim 37 further including the step of operatively coupling the spoke to the carriage via a spoke nipple and operatively coupling the carriage to the track.

39. The method of claim 38 further including the step of attaching one or more spacer carriages to the track between adjacent carriages.

40. The method of claim 38 or claim 39 further including the step of attaching an opposite end of the spoke not attached to the carriage to a hub.

41. A kit for constructing a wheel rim comprising:
(a) a rim comprising at least one track; and
(b) a plurality of spoke carriages locatable on the track and capable of being operatively coupled to a spoke.

42. The kit of claim 41 further comprising a plurality of spacer carriages locatable on the track between adjacent spoke carriages.

43. The kit of claim 41 or claim 42 further comprising a plurality of spokes respectively capable of being operatively coupled to one or more spoke carriage(s) and a hub.
